(19) United States
(12) Patent Application Publication
(10) Pub. No.: US 2026/0214346 A1
(43) Pub. Date: Jul. 23, 2026

(54) IMAGING DEVICE

(71) Applicant: TOYOTA JIDOSHA KABUSHIKI KAISHA, Aichi-ken (JP)

(72) Inventors: Satoshi NAITO, Yokohama-shi (JP); Shoichi SHIDO, Toyota-shi (JP)

(21) Appl. No.: 19/452,401

(22) Filed: Jan. 19, 2026

(30) Foreign Application Priority Data
Jan. 23, 2025 (JP) 2025-009889

(51) Int. Cl. H04N 23/73; H04N 23/20; H04N 23/56

(52) U.S. Cl. CPC H04N 23/73; H04N 23/20; H04N 23/56

(57) ABSTRACT

An imaging device 1 includes: a first camera module including a first camera and a first irradiation unit; a second camera module including a second camera and a second irradiation unit; an imaging control unit configured to output one synchronization signal in each predetermined cycle; and a timing adjustment unit provided in a device different from a device provided with the imaging control unit. The first camera module starts irradiation by the first irradiation unit at a timing when the synchronization signal is output from the imaging control unit. When the timing adjustment unit receives the synchronization signal from the imaging control unit, the timing adjustment unit starts irradiation by the second irradiation unit later than a timing when the irradiation by the first irradiation unit according to the synchronization signal is ended and earlier than a timing of receiving the next synchronization signal.

### FIELD

The present disclosure relates to an imaging device.

### BACKGROUND

In the related art, there has been known an imaging system in which each vehicle includes an infrared camera module that performs imaging after irradiation of infrared light, and imaging is performed at the same timing by the infrared camera modules of a plurality of the vehicles (JP 6743708 B). In particular, in the imaging system described in Patent Document 1, imaging timings of the infrared camera modules equipped on different vehicles are controlled via inter-vehicle communication between the vehicles.

In the imaging system described in JP 6743708 B, the imaging timings of the infrared camera modules equipped on different vehicles are synchronized by the inter-vehicle communication, but an irradiation timing of infrared light may deviate from an appropriate timing.

In view of the above problem, an object of the present disclosure is to suppress the deviation of the irradiation timing of light from an appropriate timing.

### SUMMARY

The present disclosure includes the following aspects.
(1) An imaging device configured to perform imaging, comprising:
   a first camera module including a first camera, and a first irradiation unit configured to irradiate an imaging range of the first camera with invisible light during an exposure period of the first camera;
   a second camera module including a second camera, and a second irradiation unit configured to irradiate an imaging range of the second camera with invisible light during an exposure period of the second camera;
   an imaging control unit configured to output one synchronization signal in each predetermined cycle; and
   a timing adjustment unit provided in a device different from a device provided with the imaging control unit and configured to receive the synchronization signal from the imaging control unit, wherein
   an irradiation range of the first irradiation unit at least partially overlaps an irradiation range of the second irradiation unit,
   the first camera module starts irradiation by the first irradiation unit at a timing when the synchronization signal is output from the imaging control unit, and
   when the timing adjustment unit receives the synchronization signal from the imaging control unit, the timing adjustment unit starts irradiation by the second irradiation unit later than a timing when the irradiation by the first irradiation unit according to the synchronization signal is ended and earlier than a timing of receiving the next synchronization signal.
(2) The imaging device according to claim 1, wherein
   the timing adjustment unit is provided in the second camera module.
(3) The imaging device according to claim 1, further comprising:
   a frame synchronization branching device that is a device different from the device provided with the imaging control unit, the first camera module, and the second camera module, wherein
   the frame synchronization branching device receives the synchronization signal from the imaging control unit and transmits signals to start the irradiation by the first irradiation unit and the irradiation by the second irradiation unit to the first camera module and the second camera module, respectively, and
   the timing adjustment unit is provided in the frame synchronization branching device.
(4) The imaging device according to any one of claims 1 to 3, wherein
   the timing adjustment unit includes a circuit configured to start the irradiation by the second irradiation unit later than a timing of receiving the synchronization signal.
(5) The imaging device according to any one of claims 1 to 4, wherein
   the imaging control unit transmits an offset time to the timing adjustment unit at a timing different from a timing of transmitting the synchronization signal, and
   the timing adjustment unit starts the irradiation by the second irradiation unit when the offset time has elapsed after receiving the synchronization signal.
(6) The imaging device according to any one of claims 1 to 5, wherein
   the first camera module starts exposure in the first camera at a timing when the synchronization signal is output from the imaging control unit, and
   when the timing adjustment unit receives the synchronization signal from the imaging control unit, the timing adjustment unit starts exposure in the second camera later than the timing when the exposure in the first camera according to the synchronization signal is ended and earlier than the timing of receiving the next synchronization signal.
(7) The imaging device according to any one of claims 1 to 6, wherein
   the first camera and the second camera are cameras having sensitivity to invisible light, and
   the first irradiation unit and the second irradiation unit emit the invisible light.
(8) The imaging device according to claim 7, wherein
   the invisible light is infrared light.
(9) The imaging device according to any one of claims 1 to 8, wherein
   the imaging device is equipped on one vehicle.
(10) The imaging device according to claim 9, wherein
   the first camera and the second camera are disposed to image the same passenger of the vehicle.

### BRIEF DESCRIPTION OF DRAWINGS

FIG. 1 is a configuration diagram schematically illustrating a configuration of an imaging device.

FIG. 2 is a schematic side view partially illustrating an interior of a vehicle equipped with the imaging device.

FIG. 3 is a block diagram showing the flow of signals.

FIG. 4 is a time chart showing an irradiation timing and the like of infrared light by a first projector.

FIG. 5 is a block diagram similar to FIG. 3, showing the flow of signals.

### DESCRIPTION OF EMBODIMENTS

Hereinafter, embodiments will be described in detail with reference to the drawings. In the following description, similar components are denoted by the same reference numerals.

### First Embodiment

### Configuration of Imaging Device

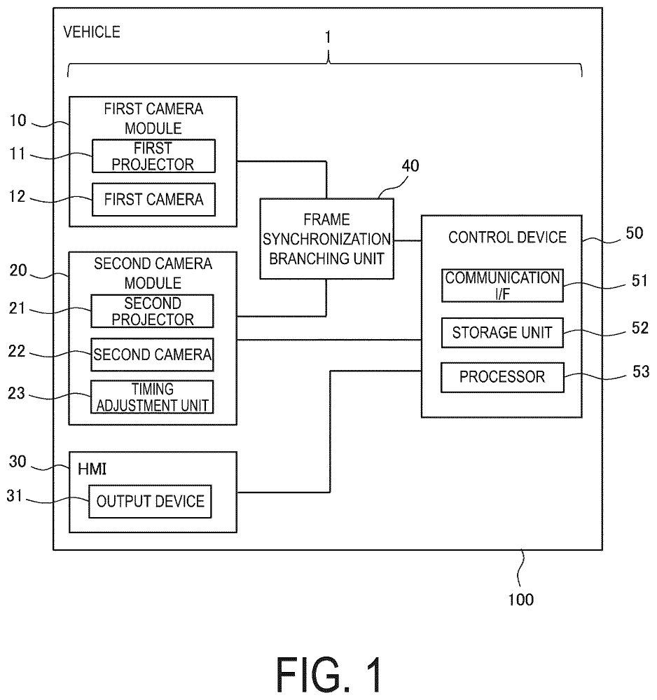

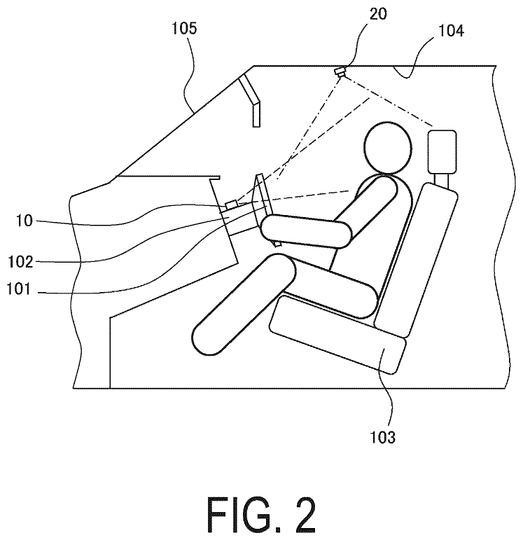

First, a configuration of an imaging device 1 according to a first embodiment will be described with reference to FIGS. 1 and 2. FIG. 1 is a configuration diagram schematically illustrating a configuration of an imaging device 1 according to a first embodiment. FIG. 2 is a schematic side view partially illustrating an interior of a vehicle 100 equipped with the imaging device 1. The imaging device 1 is equipped on one vehicle 100 and performs imaging of an object in the vehicle 100. In the present embodiment, the imaging device 1 images the object in the vehicle 100, for example, a passenger of the vehicle 100, by a plurality of cameras whose imaging ranges at least partially overlap each other.

In the present embodiment, the imaging device 1 includes a first camera module 10, a second camera module 20, a human-machine interface (HMI) 30, a frame synchronization branching device 40, and a control device 50. The first camera module 10, the second camera module 20, the human-machine interface (HMI) 30, the frame synchronization branching device 40, and the control device 50 are different devices from each other. The first camera module 10 and the second camera module 20 are connected to the control device 50 via signal lines and the frame synchronization branching device 40. The second camera module 20 and the HMI 30 are connected to the control device 50 via signal lines.

The first camera module 10 images a driver (particularly, a face of the driver) for the main purpose of detecting a face direction, a line-of-sight direction, an open/closed state of eyes, and the like of the driver of the vehicle 100. In the present embodiment, as illustrated in FIG. 2, the first camera module 10 is disposed on an upper portion of a steering column 102 so as to face the face of the driver. The first camera module 10 may be disposed on a steering wheel 101, a room mirror, a meter panel, a meter hood, or the like as long as the first camera module 10 can image the face of the driver.

The first camera module 10 includes a first projector 11 and a first camera 12. In the present embodiment, the first projector 11 and the first camera 12 are integrally configured, but the first projector 11 and the first camera 12 may be separately disposed as separate devices. The first camera module 10 starts irradiation of the infrared light by the first projector 11 and imaging (exposure) in the first camera 12 according to a synchronization signal received from the frame synchronization branching device 40. In particular, in the present embodiment, when the first camera module 10 receives the synchronization signal from the frame synchronization branching device 40, the first camera module 10 starts the irradiation of the infrared light by the first projector 11 and the imaging (exposure) in the first camera 12 at a timing of receiving the synchronization signal.

The first projector 11 is an example of a first irradiation unit that irradiates an imaging range of the first camera 12 with infrared light. In the present embodiment, the first projector 11 emits the infrared light of a predetermined wavelength (for example, 850 nm or 940 nm) during an exposure period in the first camera 12. The first projector 11 includes an infrared light emitting diode that emits the infrared light.

The first camera 12 is a camera having sensitivity to the infrared light, and receives reflected light of the infrared light emitted from the first projector 11 and reflected by a subject, and performs imaging. The first camera 12 transmits the imaged image to the control device 50. The first camera 12 includes an image sensor (for example, a complementary metal oxide semiconductor (CMOS) image sensor or a charge coupled device (CCD) image sensor), a filter that transmits the infrared light, and an imaging optical system that forms an image of a region to be imaged on a photoelectric conversion element (for example, a photodiode) of the image sensor.

The image sensor of the first camera 12 includes a photoelectric conversion element such as a photodiode and a capacitor. In particular, the image sensor includes a plurality of the photoelectric conversion elements arranged in a two dimensional array and a plurality of the capacitors corresponding to the respective photoelectric conversion elements.

When the photoelectric conversion element receives light, the photoelectric conversion element generates charges corresponding to an intensity of the received light, and the capacitor accumulates the charges generated in the photoelectric conversion element. In the present embodiment, since the filter is disposed in front of the image sensor, the photoelectric conversion element generates the charges corresponding to the intensity of the infrared light. The first camera 12 can change an exposure period that is a period in which the charges accumulated in the capacitor are generated in the photoelectric conversion element by irradiating the photoelectric conversion element with the light. In the present specification, the generation of the charges accumulated in the capacitor in the photoelectric conversion element by irradiating the photoelectric conversion element with light is referred to as exposure in the camera.

The capacitor accumulates the charges generated in the photoelectric conversion element during the exposure period, and the charges accumulated in the capacitor are transferred after completion of the exposure period. The intensity of light received by the photoelectric conversion element corresponding to each pixel is detected according to the amount of the charges transferred in this manner. In the present specification, such transfer of the charges from the capacitor is referred to as readout in the camera.

The second camera module 20 images a seat 103 (or a region including a hand of a passenger (a driver and an occupant on a passenger seat) seated on the seat 103) from above for the main purpose of detecting a movement (for example, an operation of a navigation device, and a pointing movement) of the hand of the passenger seated on the seat 103 (including the passenger seat) of the vehicle 100. As illustrated in FIG. 2, the second camera module 20 is disposed on a ceiling 104 of the vehicle 100 so as to face the seat 103. Thus, the face of the driver is included in an imaging range of the second camera module 20, and thus an imaging range of the first camera module 10 and the imaging range of the second camera module 20 partially overlap each other. In particular, in the present embodiment, the first camera module 10 and the second camera module 20 are disposed so as to image the same passenger (driver). The second camera module 20 may be disposed on an upper portion of a front window 105 or the like as long as the second camera module 20 can image the seat 103 from above.

The second camera module 20 also includes a second projector 21 and a second camera 22, similarly to the first camera module 10. In addition, the second camera module 20 includes a timing adjustment unit 23. In the present embodiment, the second projector 21, the second camera 22, and the timing adjustment unit 23 are integrally configured, but may be separately disposed as separate devices. The second camera module 20 also starts the irradiation of the infrared light by the second projector 21 and the imaging (exposure) in the second camera 22 in response to the synchronization signal received from the frame synchronization branching device 40.

The second projector 21 is an example of a second irradiation unit that irradiates an imaging range of the second camera 22 with the infrared light. The second projector 21 has a configuration similar to that of the first projector 11. Thus, during the exposure period of the second camera 22, the second projector 21 emits the infrared light having the same or substantially the same wavelength as the infrared light emitted by the first projector 11.

The second camera 22 is a camera having sensitivity to the infrared light, and receives reflected light of the infrared light emitted from the second projector 21 and reflected by a subject, and performs imaging. The second camera 22 also transmits the imaged image to the control device 50. The second camera 22 also has a configuration similar to that of the first camera 12, and includes an image sensor, a filter, and an imaging optical system.

The timing adjustment unit 23 includes, for example, a digital circuit that delays a signal by a timer. When the timing adjustment unit 23 receives the synchronization signal from the frame synchronization branching device 40, the timing adjustment unit 23 starts the irradiation of the infrared light by the second projector 21 and the exposure in the second camera 22 at a timing delayed by a predetermined delay time from the timing of receiving the synchronization signal. Thus, the timing adjustment unit 23 includes a circuit that starts the irradiation of the infrared light by the second projector 21 and the exposure in the second camera 22 later than the timing of receiving the synchronization signal. As described above, in the present embodiment, the delay of the start of the irradiation of the infrared light by the second projector 21 and the exposure in the second camera 22 with respect to the synchronization signal is performed on hardware, not on software. Thus, an occurrence of a deviation in the delay due to an increase in the load of other processing of a processor 53 or the like is suppressed.

Further, when the timing adjustment unit 23 receives a signal indicating an offset time from the processor 53 of the control device 50, the timing adjustment unit 23 sets the above-described delay time to the offset time. Thus, when the timing adjustment unit 23 receives the synchronization signal from the frame synchronization branching device 40, the timing adjustment unit 23 starts the irradiation of the infrared light by the second projector 21 and the exposure in the second camera 22 at a timing delayed by the offset time from the timing of receiving the synchronization signal.

The first camera module 10 and the second camera module 20 may be used for purposes different from the above-described purposes. For example, the second camera module 20 may be used for the main purpose of detecting a wearing/unwearing state of the seat belt of the passenger seated on each seat of the vehicle 100. Alternatively, the second camera module 20 may be used for the main purpose of detecting an operation of a smartphone by the driver of the vehicle 100.

In addition, the first camera module 10 and the second camera module 20 may be disposed at positions different from the above-described positions. For example, both the first camera module 10 and the second camera module 20 may be disposed on the ceiling 104 so as to image the sheet 103 from above at different angles. In this case, for example, one camera module is used for the main purpose of detecting the wearing/unwearing state of the seat belt of the passenger, and the other camera module is used for the main purpose of detecting the movement of the hand of the passenger.

However, in any case, the first camera module 10 and the second camera module 20 are disposed such that the imaging range of the first camera 12 and the imaging range of the second camera 22 at least partially overlap each other. Thus, in either case, the first camera module 10 and the second camera module 20 are disposed such that the irradiation range of the infrared light by the first projector 11 and the irradiation range of the infrared light by the second projector 21 at least partially overlap each other.

Further, the first projector 11 and the second projector 21 project the infrared light, but may project invisible light other than the infrared light. The first camera 12 and the second camera 22 may be cameras having sensitivity to the invisible light other than the infrared light.

In the present embodiment, the imaging device 1 includes two camera modules, namely, the first camera module 10 and the second camera module 20. However, the imaging device 1 may include three or more camera modules. In this case, for each of the plurality of camera modules, the imaging range of each camera at least partially overlaps the imaging range of another camera, and thus the irradiation range of the infrared light by each projector at least partially overlaps the irradiation range of the infrared light by another projector.

The HMI 30 is a user interface for exchanging information between the vehicle 100 and the passenger of the vehicle 100. The HMI 30 includes an output device 31 for notifying the passenger through a body sensation (for example, a sense of sight, a sense of hearing, and a sense of touch) of the passenger. The output device 31 is, for example, displays (for example, a meter display, a center display, and a head-up display), a speaker, and a vibrating body. For example, in the control device 50, when inattentiveness or drowsiness of the driver is detected based on the image imaged by the first camera 12, a warning is issued to the passenger by the output device 31.

The frame synchronization branching device 40 branches the signal received from the processor 53 of the control device 50 and transmits the branched signals to the first camera module 10 and the second camera module 20. In addition, the frame synchronization branching device 40 receives image data from the first camera module 10 and the second camera module 20 and collectively transmits the received image data to the processor 53. In the present embodiment, the frame synchronization branching device 40 is, for example, a serializer/deserializer (SerDes). In particular, in the present embodiment, when the frame synchronization branching device 40 receives a synchronization signal from an imaging control unit 531 of the processor 53 described later, the frame synchronization branching device 40 transmits the synchronization signals to the first camera module 10 and the second camera module 20 at the timing of receiving the synchronization signal.

The control device 50 controls the first camera module 10 (the first projector 11 and the first camera 12), the second camera module 20 (the second projector 21 and the second camera 22), and the HMI 30. In the present embodiment, the control device 50 controls a timing of irradiation start and irradiation time by the projectors 11 and 21 of both camera modules, that is, controls the irradiation period by the projectors 11 and 21. The control device 50 controls a timing of exposure start and the exposure time by the cameras 12 and 22 of both camera modules, that is, controls the exposure period in the cameras 12 and 22. In addition, the control device 50 controls notification to the passenger by the output device 31 of the HMI 30.

The control device 50 includes a communication interface 51, a storage unit 52, and a processor 53. The communication interface 51, the storage unit 52, and the processor 53 may be configured as separate circuits or may be configured as a single integrated circuit such as a system on a chip (SoC).

The communication interface 51 includes an interface circuit for connecting the control device 50 to other devices such as the first camera module 10. The control device 50 is connected to other devices via the communication interface 51. The communication interface 51 transmits data representing the imaged images received from the first camera module 10 and the second camera module 20 to the processor 53. The communication interface 51 transmits a signal output from the processor 53 to the first camera module 10, the second camera module 20, and the output device 31 of the HMI 30.

The storage unit 52 is a device that stores data, and is a non-transitory storage medium. The storage unit 52 includes, for example, a volatile semiconductor memory (for example, a dynamic random access memory (DRAM) and a static random access memory (SRAM)) and a nonvolatile semiconductor memory (for example, a read only memory (ROM), an electrically erasable programmable read only memory (EEPROM), and a flash memory). The storage unit 52 may include a hard disk drive (HDD) and a solid state drive (SSD). The storage unit 52 stores a computer program executed by the processor 53. The storage unit 52 stores data and the like representing images imaged by the first camera 12 and the second camera 22.

The processor 53 includes one or a plurality of CPUs (Central Processing Units) and a peripheral circuit thereof. The processor 53 may further include another operation circuit such as a logic operation unit, an arithmetic logic unit, or a graphics processor unit. The processor 53 executes the computer program stored in the storage unit 52.

### Control of Camera Module

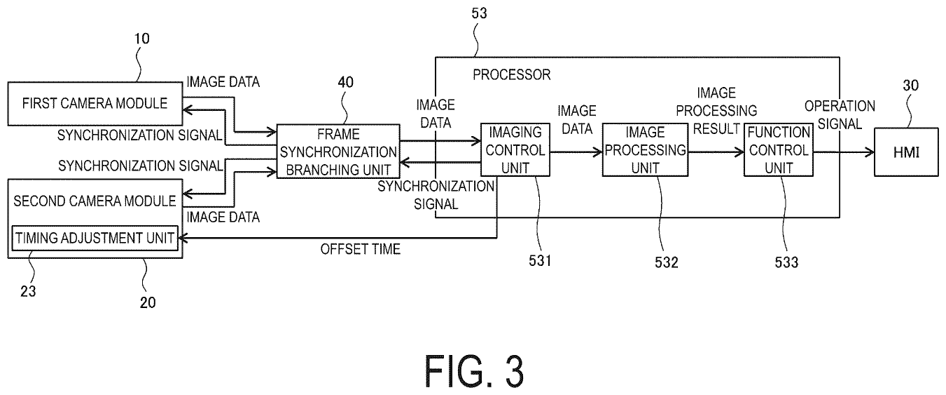

FIG. 3 is a block diagram showing the flow of signals. As illustrated in FIG. 3, the processor 53 includes an imaging control unit 531, an image processing unit 532, and a function control unit 533. These units included in the processor 53 are, for example, functional modules executed by the computer program operating on the processor 53. Alternatively, these units included in the processor 53 may be mounted to the control device 40 as independent integrated circuits, microprocessors, or firmware.

The imaging control unit 531 outputs one synchronization signal in each optional frame processing cycle T. In particular, in the present embodiment, the imaging control unit 531 outputs the synchronization signal only to the frame synchronization branching device 40. Thus, in the processor 53 including the imaging control unit 531 or the control device 50 including one integrated circuit including the processor 53, the number of pins for outputting the synchronization signal can be minimized.

When the frame synchronization branching device 40 receives the synchronization signal from the imaging control unit 531, the frame synchronization branching device 40 transmits the synchronization signal to the first camera module 10 and the second camera module 20 at the timing of receiving the synchronization signal. Thus, when one synchronization signal is output from the imaging control unit 531, the synchronization signal is input to the first camera module 10 and the second camera module 20 via the frame synchronization branching device 40 at the timing when the synchronization signal is output from the imaging control unit 531.

As described above, when the first camera module 10 receives the synchronization signal, the first camera module 10 starts the irradiation of the infrared light by the first projector 11 and the exposure in the first camera 12 at the timing of receiving the synchronization signal. Thus, the first camera module 10 starts the irradiation of the infrared light by the first projector 11 and the exposure in the first camera 12 at the timing when the synchronization signal is output from the imaging control unit 531.

The first camera module 10 continues the irradiation of the infrared light from the first projector 11 over a predetermined irradiation request time. In addition, the first camera module 10 continues the exposure in the first camera 12 over a predetermined exposure request time. In the present embodiment, the predetermined irradiation request time and the predetermined exposure request time are the same time. Alternatively, the signals representing the irradiation request time and the exposure request time may be included in the synchronization signal. In this case, the first camera module 10 continues the irradiation of the infrared light from the first projector 11 and the exposure in the first camera 12 over the irradiation request time and the exposure request time, respectively, included in each synchronization signal.

In the first camera 12, when the exposure is completed, the readout is performed and the image data is generated. When the image data is generated, the first camera module 10 transmits the generated image data to the imaging control unit 531 via the frame synchronization branching device 40.

On the other hand the second camera module 20 includes the timing adjustment unit 23. When the timing adjustment unit 23 receives the synchronization signal from the imaging control unit 531 via the frame synchronization branching device 40, the timing adjustment unit 23 starts the irradiation of the infrared light by the second projector 21 and the exposure in the second camera 22 at a timing delayed by a predetermined delay time (offset time) from the timing of receiving the synchronization signal.

The second camera module 20 continues the irradiation of the infrared light from the second projector 21 over a predetermined irradiation request time. In addition, the second camera module 20 continues the exposure in the second camera 22 over a predetermined exposure request time. In the present embodiment, the predetermined irradiation request time and the predetermined exposure request time are the same time. Alternatively, the signals representing the irradiation request time and the exposure request time may be included in the synchronization signal. In this case, the second camera module 20 continues the irradiation of the infrared light from the second projector 21 and the exposure in the second camera 22 over the irradiation request time and the exposure request time, respectively, included in each synchronization signal.

Also in the second camera 22, when the exposure is completed, the readout is performed and the image data is generated. When the image data is generated, the second camera module 20 transmits the generated image data to the imaging control unit 531 via the frame synchronization branching device 40.

The imaging control unit 531 transmits the offset time to the timing adjustment unit 23 of the second camera module 20. The offset time is transmitted at the timing when the imaging device 1 is activated. In addition, in a case where the frame processing cycle T is changed during use in the imaging device 1, the offset time is transmitted at the changed timing. Thus, in the present embodiment, the imaging control unit 531 transmits the offset time to the timing adjustment unit 23 at a timing different from a timing of transmitting the synchronization signal and at a frequency lower than a frequency of transmitting the synchronization signal. In the present embodiment, the offset time ΔT is set to, for example, a half time of the frame processing cycle T (ΔT=T/2). in a case where the imaging device 1 includes three or more camera modules, the offset time ΔT is set to, for example, a time obtained by dividing the frame processing cycle T by the number of the camera modules.

In the present embodiment, the offset time is transmitted from the imaging control unit 531 to the timing adjustment unit 23. However, for example, in a case where the frame processing cycle T is a fixed value, the offset time may be a predetermined fixed value. In this case, the offset time is not transmitted from the imaging control unit 531 to the timing adjustment unit 23, but is stored in the timing adjustment unit 23.

Further, the imaging control unit 531 receives, from the camera modules 10 and 20, data (image data) representing images imaged by the cameras 12 and 22 of the camera modules 10 and 20 via the frame synchronization branching device 40. When the imaging control unit 531 receives the image data, the imaging control unit 531 transmits the received image data to the image processing unit 532. The image processing unit 532 may directly receive the image data from each of the camera modules 10 and 20 without passing through the frame synchronization branching device 40 and the imaging control unit 531.

The image processing unit 532 analyzes the image including the face of the driver imaged by the first camera 12 and detects the face direction, the line-of-sight direction, a degree of eye opening of the eyes, and the like of the driver. The detection of the face direction of the driver and the like is performed by any image processing method such as using a learned machine learning model. In the present embodiment, the image processing unit 532 analyzes an image of the surroundings of each seat 103 imaged by the second camera 22, and detects the movement of the hand of the passenger seated on each seat 103. The detection of the movement of the hand of the passenger is also performed by any image processing method such as using the learned machine learning model. The image processing unit 532 transmits data representing the detected face direction of the driver and the like and data representing the movement of the hand of the passenger to the function control unit 533.

The function control unit 533 controls a function of the vehicle 100 based on the data representing the result of the image processing received from the image processing unit 532.

In the present embodiment, the function control unit 533 detects inattentiveness or drowsiness of the driver based on the face direction, the line-of-sight direction, and the degree of eye opening of the eyes of the driver transmitted from the image processing unit 532, and controls the HMI 30 according to the detection result. For example, when the inattentiveness or drowsiness of the driver is detected, the function control unit 533 transmits a signal instructing the output device 31 of the HMI 30 to execute a warning to the passenger.

In the present embodiment, the function control unit 533 detects whether the operation of the navigation device or the pointing movement by the passenger is performed based on the data representing the movement of the hand of the passenger transmitted from the image processing unit 532, and controls the HMI 30 according to the detection result. For example, when the pointing movement by the passenger is detected, the function control unit 533 searches for a shop or the like present in a pointing direction of the passenger, and transmits a signal for instructing the output device 31 of the HMI 30 to execute notification of information of the searched shop or the like to the passenger.

### Temporal Flow in Control

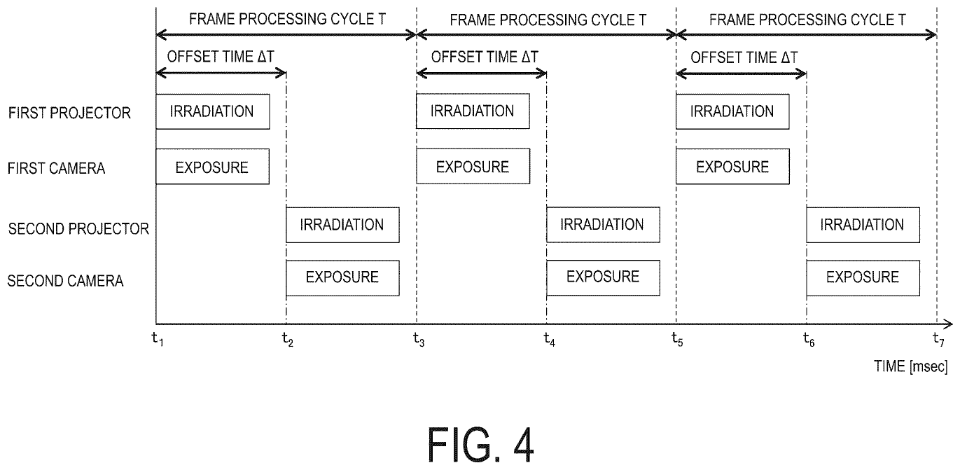

Next, a temporal flow in control of the first camera module 10 and the second camera module 20 by the control device 40 will be described with reference to FIG. 4.

When the exposure to the light in the first camera 12 and the exposure to the light in the second camera 22 are simultaneously performed, the irradiation of the infrared light by the first projector 11 and the irradiation of the infrared light by the second projector 21 are simultaneously performed. On the other hand, as described above, the imaging range of the first camera 12 and the imaging range of the second camera 22 partially overlap each other, and thus the irradiation range of the infrared light by the first projector 11 and the irradiation range of the infrared light by the second projector 21 partially overlap each other. Thus, when the irradiation of the infrared light from the first projector 11 and the irradiation of the infrared light from the second projector 21 are simultaneously performed, the quality of images imaged by the first camera 12 and the second camera 22 may deteriorate (for example, halation, and formation of unnecessary shadows) in the region where the irradiation of the infrared light from the first projector 11 and the irradiation of the infrared light from the second projector 21 overlap each other. In particular, in the present embodiment, the first camera 12 and the second camera 22 are disposed so as to image the same passenger (driver), and deterioration of image quality may occur in a portion that is most necessary in the control of the vehicle 100.

Thus, in the present embodiment, in each piece of frame processing performed in each frame processing cycle T, the camera modules 10 and 20 are controlled so that a first irradiation/exposure period, which is a period in which the irradiation of the infrared light by the first projector 11 and the exposure in the first camera 12 are performed, does not overlap a second irradiation/exposure period, which is a period in which the irradiation of the infrared light by the second projector 21 and the exposure in the second camera 22 are performed. Thus, the deterioration of the image quality in the infrared image imaged by the first camera 12 and the second camera 22 is suppressed.

FIG. 4 is a time chart showing an irradiation timing of the infrared light by the first projector 11, exposure timings in the first camera 12, an irradiation timing of the infrared light by the second projector 21, and exposure timings in the second camera 22.

As illustrated in FIG. 4, in the present embodiment, the frame processing is performed at every optional frame processing cycle T (for example, several tens [ms] to several hundreds [ms]), and thus imaging by the camera modules 10 and 20 is performed at every frame processing cycle T. In the example illustrated in FIG. 4, at a time t₁, which is a start timing of the frame processing, the first camera module 10 and the second camera module 20 receive the synchronization signal from the imaging control unit 531 via the frame synchronization branching device 40. As a result, at the time t₁, the irradiation of the infrared light by the first projector 11 and the exposure in the first camera 12 are started.

The irradiation of the infrared light by the first projector 11 is performed over the irradiation request time included in the synchronization signal. Similarly, the exposure in the first camera 12 is performed over the exposure request time included in the synchronization signal. In the present embodiment, the irradiation request time and the exposure request time are a time shorter than half of the frame processing cycle T (that is, corresponding to the offset time ΔT). In other words, the frame processing cycle T is set so that the offset time ΔT is longer than the exposure time necessary for imaging an appropriate image.

When the irradiation request time has elapsed from the start of the irradiation of the infrared light by the first projector 11, the irradiation of the infrared light is ended. In addition, when the exposure request time elapses from the start of the exposure in the first camera 12, the exposure is ended. When the exposure in the first camera 12 is ended, the readout is performed to generate the image data, and the generated image data is transmitted to the imaging control unit 531.

In the example shown in FIG. 4, at a time t₂ when the offset time ΔT has elapsed from the time t₁, the irradiation of the infrared light by the second projector 21 and the exposure to the infrared light in the second camera 22 are started by the timing adjustment unit 23 of the second camera module 20.

The irradiation of the infrared light by the second projector 21 is performed over the irradiation request time included in the synchronization signal. Similarly, the exposure in the second camera 22 is performed over the exposure request time included in the synchronization signal. Thus, in the present embodiment, the irradiation time of the infrared light by the second projector 21 in each piece of the frame processing is the same as the irradiation time of the infrared light by the first projector 11 in each piece of the frame processing. Similarly, the exposure time in the second camera 22 in each piece of the frame processing is the same as the exposure time in the first camera 12 in each piece of the frame processing.

The irradiation request time for the first projector 11 may be different from the irradiation request time for the second projector 21. The exposure request time for the first camera 12 may be different from the exposure request time for the second camera 22. However, in any case, the offset time ΔT is set to a time longer than the irradiation request time for the first projector 11 and the exposure request time for the first camera 12. The time obtained by subtracting the offset time ΔT from the frame processing cycle T is set to a time longer than the irradiation request time for the second projector 21 and the exposure request time for the second camera 22.

When the irradiation request time elapses from the start of the irradiation of the infrared light by the second projector 21, the irradiation of the infrared light is ended. In addition, when the exposure request time elapses from the start of the exposure in the second camera 22, the exposure is ended. When the exposure in the second camera 22 is ended, the readout is performed to generate the image data, and the generated image data is transmitted to the imaging control unit 531.

In the example shown in FIG. 4, the frame processing as described above is repeated for each frame processing cycle T. Thus, at times t₃ and t₅ when the frame processing cycle T has repeatedly elapsed from the time t₁, the irradiation of the infrared light by the first projector 11 and the exposure in the first camera 12 are started. In addition, at times t₄ and t₆ when the offset time ΔT of each piece of the frame processing has elapsed, the irradiation of the infrared light by the second projector 21 and the exposure in the second camera 22 are started.

As described above, the timing adjustment unit 23 starts the irradiation of the infrared light by the second projector 21 and the exposure in the second camera 22 after the offset time ΔT has elapsed after receiving the synchronization signal. The offset time ΔT is longer than the irradiation request time and the exposure request time and shorter than the frame processing cycle T. Thus, when the timing adjustment unit 23 receives the synchronization signal from the imaging control unit 531, the timing adjustment unit 23 starts the irradiation of the infrared light by the second projector 21 and the exposure in the second camera 22 later than a timing when the irradiation of the infrared light by the first projector 11 according to the synchronization signal is ended and earlier than a timing of receiving a next synchronization signal.

Note that in a case where the imaging device 1 includes three or more camera modules, the imaging control unit 531 controls these camera modules such that an irradiation/exposure period of each camera module does not overlap an irradiation/exposure period of the other camera modules.

The control device 50 that is a device provided with the imaging control unit 531 performs not only control of the irradiation of the infrared light and the exposure in the camera modules 10 and 20 but also various other pieces of processing. Thus, when start timings of the irradiation of the infrared light by the second projector 21 and the exposure in the second camera 22 are also controlled by the control device 50, a deviation occurs in the start timings when the load of other pieces of processing increases. As a result, the irradiation of the infrared light of the first projector 11 and the irradiation of the infrared light of the second projector 21 are simultaneously performed, and deterioration in quality of the images imaged by the first camera 12 and the second camera 22 may occur. In contrast, in the present embodiment, the start timings of the irradiation of the infrared light of the second projector 21 and the exposure in the second camera 22 are controlled by the timing adjustment unit 23 provided in the second camera module 20 that is a device different from the control device 50 (or the processor 53) that is a device provided with the imaging control unit 531 that outputs the synchronization signal. As a result, the occurrence of the deviation in the start timings of the irradiation of the infrared light of the second projector 21 and the exposure in the second camera 22 is suppressed, and thus the occurrence of the deterioration in the image quality of the image imaged by the first camera 12 or the second camera 22 is suppressed.

In the present embodiment, the imaging control unit 531 transmits the offset time ΔT to the timing adjustment unit 23 at a timing such as the timing when the imaging device 1 is activated, which is different from the timing of transmitting the synchronization signal. Here, when the offset time ΔT is transmitted at the same timing as the synchronization signal or the offset time ΔT is included in the synchronization signal, the offset time ΔT may not be appropriately transmitted to the timing adjustment unit 23 when the processing load of the imaging control unit 531 increases. In contrast, in the present embodiment, since the offset time ΔT is transmitted at the timing different from the timing of transmitting the synchronization signal and at the frequency lower than the frequency of transmitting the synchronization signal, even when the processing load of the imaging control unit 531 increases, it is possible to suppress the offset time ΔT from not being appropriately transmitted to the timing adjustment unit 23.

In addition, in the present embodiment, the timing adjustment unit 23 is provided in the second camera module 20. Thus, the entire circuit of the imaging device 1 can be suppressed from becoming complicated as compared with a case where, for example, the timing adjustment unit is separately disposed on a signal line between the frame synchronization branching device 40 and the second camera module 20.

### Second Embodiment

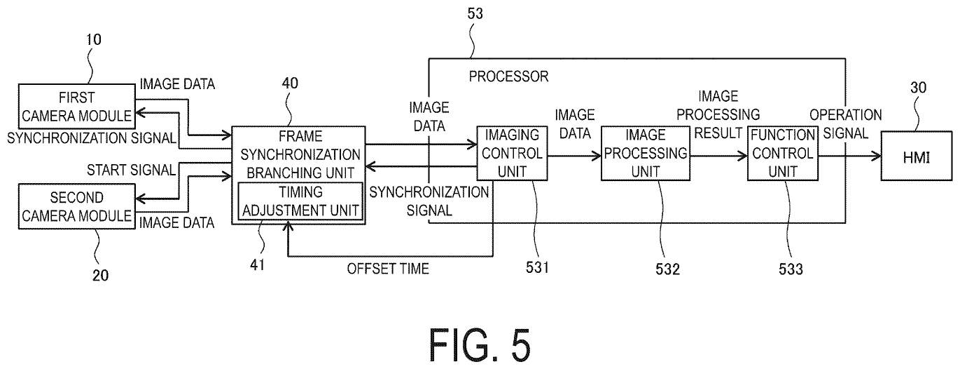

Next, the imaging device 1 according to a second embodiment will be described with reference to FIG. 5. The configuration and control of the imaging device 1 according to the second embodiment are basically the same as the configuration and control of the imaging device 1 according to the first embodiment. Hereinafter, portions different from the imaging device 1 according to the first embodiment will be mainly described.

In the first embodiment, the timing adjustment unit 23 is provided in the second camera module 20. However, in the second embodiment, a timing adjustment unit 41 is not provided in the second camera module 20 but is provided in the frame synchronization branching device 40. Thus, it is not necessary to provide the timing adjustment unit in some of the camera modules, and all the camera modules can have the same configuration, and thus the manufacturing cost of the camera modules can be reduced.

Also in the present embodiment, the timing adjustment unit 41 includes a digital circuit that delays a signal by a timer. When the timing adjustment unit 41 receives the synchronization signal from the imaging control unit 531, the timing adjustment unit 41 transmits a start signal to the second camera module 20 at a timing delayed by a predetermined delay time from the timing of receiving the synchronization signal. The start signal is a signal similar to the synchronization signal transmitted from the frame synchronization branching device 40 to the first camera module 10. Thus, when the second camera module 20 receives the start signal from the timing adjustment unit 41, the second camera module 20 starts the irradiation of the infrared light by the second projector 21 and the exposure in the second camera 22 at the timing of receiving the start signal. In any case, in the present embodiment, the frame synchronization branching device 40 receives the synchronization signal from the imaging control unit 531 and transmits signals for starting the irradiation of the infrared light by the first projector 11 and the irradiation of the infrared light by the second projector 21 to the first camera module 10 and the second camera module 20, respectively.

In the present embodiment, the imaging control unit 531 transmits the offset time to the timing adjustment unit 41 of the frame synchronization branching device 40. Also in the present embodiment, the imaging control unit 531 transmits the offset time to the timing adjustment unit 41 at a timing different from the timing of transmitting the synchronization signal and at a frequency lower than the frequency of transmitting the synchronization signal.

FIG. 5 is a block diagram similar to FIG. 3, showing the flow of signals. Also in the present embodiment, the imaging control unit 531 outputs one synchronization signal to the frame synchronization branching device 40 in each optional frame processing cycle T.

When the frame synchronization branching device 40 receives the synchronization signal from the imaging control unit 531, the frame synchronization branching device 40 transmits the synchronization signal to the first camera module 10 at the timing of receiving the synchronization signal. When the first camera module 10 receives the synchronization signal, the first camera module 10 starts the irradiation of the infrared light by the first projector 11 and the exposure in the first camera 12 at the timing of receiving the synchronization signal. Thus, the first camera module 10 starts the irradiation of the infrared light by the first projector 11 and the exposure in the first camera 12 at the timing when the synchronization signal is output from the imaging control unit 531.

On the other hand the frame synchronization branching device 40 includes the timing adjustment unit 41. When the timing adjustment unit 41 receives the synchronization signal from the imaging control unit 531, the timing adjustment unit 41 transmits the start signal to the second camera module at a timing delayed by a predetermined delay time (offset time) from the timing of receiving the synchronization signal. When the second camera module 20 receives the start signal, the second camera module 20 starts the irradiation of the infrared light by the second projector 21 and the exposure in the second camera 22 at the timing of receiving the start signal. Thus, also in the present embodiment, when the synchronization signal is output from the imaging control unit 531, the irradiation of the infrared light by the second projector 21 and the exposure in the second camera 22 are started at the timing delayed by the predetermined delay time (offset time) from the timing when the synchronization signal is output.

Although the preferred embodiments according to the present disclosure have been described above, the present disclosure is not limited to these embodiments, and various modifications and changes can be made within the scope of the claims.

1. An imaging device configured to perform imaging, comprising:
a first camera module including a first camera, and a first irradiation unit configured to irradiate an imaging range of the first camera with invisible light during an exposure period of the first camera;
a second camera module including a second camera, and a second irradiation unit configured to irradiate an imaging range of the second camera with invisible light during an exposure period of the second camera;
an imaging control unit configured to output one synchronization signal in each predetermined cycle; and
a timing adjustment unit provided in a device different from a device provided with the imaging control unit and configured to receive the synchronization signal from the imaging control unit, wherein an irradiation range of the first irradiation unit at least partially overlaps an irradiation range of the second irradiation unit,
the first camera module starts irradiation by the first irradiation unit at a timing when the synchronization signal is output from the imaging control unit, and
when the timing adjustment unit receives the synchronization signal from the imaging control unit, the timing adjustment unit starts irradiation by the second irradiation unit later than a timing when the irradiation by the first irradiation unit according to the synchronization signal is ended and earlier than a timing of receiving the next synchronization signal.

2. The imaging device according to claim 1, wherein the timing adjustment unit is provided in the second camera module.

3. The imaging device according to claim 1, further comprising:
a frame synchronization branching device that is a device different from the device provided with the imaging control unit, the first camera module, and the second camera module, wherein
the frame synchronization branching device receives the synchronization signal from the imaging control unit and transmits signals to start the irradiation by the first irradiation unit and the irradiation by the second irradiation unit to the first camera module and the second camera module, respectively, and
the timing adjustment unit is provided in the frame synchronization branching device.

4. The imaging device according to claim 1, wherein
the timing adjustment unit includes a circuit configured to start the irradiation by the second irradiation unit later than a timing of receiving the synchronization signal.

5. The imaging device according to claim 1, wherein
the imaging control unit transmits an offset time to the timing adjustment unit at a timing different from a timing of transmitting the synchronization signal, and
the timing adjustment unit starts the irradiation by the second irradiation unit when the offset time has elapsed after receiving the synchronization signal.

6. The imaging device according to claim 1, wherein
the first camera module starts exposure in the first camera at a timing when the synchronization signal is output from the imaging control unit, and
when the timing adjustment unit receives the synchronization signal from the imaging control unit, the timing adjustment unit starts exposure in the second camera later than the timing when the exposure in the first camera according to the synchronization signal is ended and earlier than the timing of receiving the next synchronization signal.

7. The imaging device according to claim 1, wherein
the first camera and the second camera are cameras having sensitivity to invisible light, and
the first irradiation unit and the second irradiation unit emit the invisible light.

8. The imaging device according to claim 7, wherein
the invisible light is infrared light.

9. The imaging device according to claim 1, wherein
the imaging device is equipped on one vehicle.

10. The imaging device according to claim 9, wherein
the first camera and the second camera are disposed to image the same passenger of the vehicle.
